(19) United States
(12) Patent Application Publication
(10) Pub. No.: US 2022/0004992 A1
(43) Pub. Date: Jan. 6, 2022

(54) CUSTOM DEVELOPMENT CROWDFUNDING MARKETPLACE

(71) Applicant: SAP SE, Walldorf (DE)

(72) Inventor: Andreas Jahr, Karlsruhe (DE)

(21) Appl. No.: 16/920,907

(22) Filed: Jul. 6, 2020

(51) Int. Cl. G06Q 10/10; G06Q 30/02; G06Q 50/00; G06F 8/77; H04L 29/06

(52) U.S. Cl. CPC G06Q 10/103; G06Q 30/0279; H04L 63/0421; G06Q 10/107; G06F 8/77; G06Q 50/01

(57) ABSTRACT

Methods, systems, and computer-readable storage media for initiating a project within a computer-implemented, network-based crowdfunding marketplace, the project including a set of participants to communicate with one another through the crowdfunding marketplace, receiving a communication from a first sub-set of participants to a second sub-set of participants, the first sub-set of participants including at least one participant, and the second sub-set of participants including at least one participant, the communication including a network-based communication, pseudonymizing, by a pseudonymization service, at least a portion of the communication to provide a pseudonymized communication, sending the pseudonymized communication to the second sub-set of participants, and decreasing pseudonymization of communications during progression of the project to reduce burden on technical resources expended for pseudonymization.

### BACKGROUND

Enterprises can use software systems to support and execute operations. In many cases, enterprises can use hundreds to thousands of software systems across a landscape. To achieve efficiencies, software vendors typically develop software systems based on needs of multiple enterprise. In some instances, software vendors incrementally improve and/or customize existing software systems.

It can occur, however, that a new software system or customization of a software system is sought. For example, different enterprise might need the same, not yet existing functionality from a software system. This can occur in multiple cases. For example, in a first case, a developer (e.g., a software vendor, a development team internal to an enterprise) may have the expertise for building the missing functionality, but the development is too expensive or with too small market to justify the expense. As another example, in a second case, a requester (e.g., an enterprise that consumes software developed by software vendors) does not have the expertise to implement development, but does have the idea of what is to be developed.

Currently, software vendors execute customer projects on one-by-one basis (e.g., software vendor and one customer), potentially sold later to other additional customers (again on a one-by-one basis). Still, one customer bears all of the cost. If it turns out that enough customers would be willing to pay, a product is created instead of conducting only a customer project. In all traditional cases, there is either no anonymization necessary (one-by-one) or no price adjustments (product).

### SUMMARY

Implementations of the present disclosure are directed to custom development of software systems. More particularly, implementations of the present disclosure are directed to a crowdfunding marketplace to support custom development of software systems.

In some implementations, actions include initiating a project within a computer-implemented, network-based crowdfunding marketplace, the project including a set of participants to communicate with one another through the crowdfunding marketplace, receiving a communication from a first sub-set of participants to a second sub-set of participants, the first sub-set of participants including at least one participant, and the second sub-set of participants including at least one participant, the communication including a network-based communication, pseudonymizing, by a pseudonymization service, at least a portion of the communication to provide a pseudonymized communication, sending the pseudonymized communication to the second sub-set of participants, and decreasing pseudonymization of communications during progression of the project to reduce burden on technical resources expended for pseudonymization. Other implementations of this aspect include corresponding systems, apparatus, and computer programs, configured to perform the actions of the methods, encoded on computer storage devices.

These and other implementations can each optionally include one or more of the following features: pseudonymization is decreased from a first level to a second level during progression of the project; the second level includes no pseudonymization; the second level is implemented in response to an event associated with the project; the communication includes one of an email message, an instant message, video communication, and a voice-over-internet-protocol (VOIP) message; pseudonymizing at least a portion of the communication includes replacing the at least a portion of the communication with pseudo-information associated with at least one participant, the at least a portion of the communication comprising actual information representative of the at least one participant; and pseudonymizing at least a portion of the communication comprises obfuscating the at least a portion of the communication, the at least a portion of the communication comprising actual information representative of the at least one participant.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for a crowdfunding marketplace in accordance with implementations of the present disclosure.

FIGS. 3A-3H and 4 depict example processes that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to custom development of software systems. More particularly, implementations of the present disclosure are directed to a crowdfunding marketplace to support custom development of software systems. Implementations can include actions of initiating a project within a computer-implemented, network-based crowdfunding marketplace, the project including a set of participants to communicate with one another through the crowdfunding marketplace, receiving a communication from a first sub-set of participants to a second sub-set of participants, the first sub-set of participants including at least one participant, and the second sub-set of participants including at least one participant, the communication including a network-based communication, pseudonymizing, by a pseudonymization service, at least a portion of the communication to provide a pseudonymized communication, sending the pseudonymized communication to the second sub-set of participants, and decreasing pseudonymization of communications during progression of the project to reduce burden on technical resources expended for pseudonymization.

As described in further detail herein, implementations of the present disclosure provide a computer-implemented crowdfunding marketplace provided by a crowdfunding marketplace operator (CMO) that enables one or more software development projects to be pushed forward through to development based on input provided by one or more participants. Example participants can include, without limitation, a software developer (also referred to herein as software vendor), customers and investor. As described in further detail herein, the crowdfunding marketplace of the present disclosure provides technical solutions that enable participants to securely and anonymously communicate through at least initial processes. For example, technical solutions include secure and anonymous communication through one or more communication channels that enable participants to define requirements and execute contracts to move a project for to development of a software system.

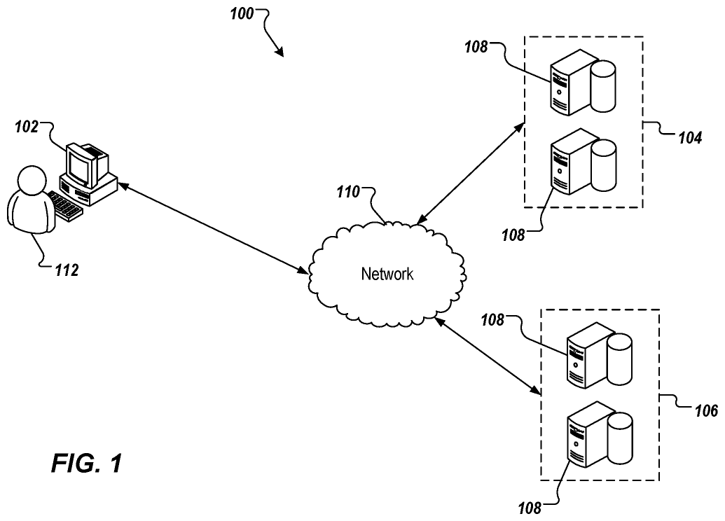

FIG. 1 depicts an example architecture 100 in accordance with implementations of the present disclosure. In the depicted example, the example architecture 100 includes a client device 102, a network 110, and server systems 104, 106. The server systems 104, 106 each include one or more server devices and databases 108 (e.g., processors, memory). In the depicted example, a user 112 interacts with the client device 102.

In some examples, the client device 102 can communicate with the server system 104 and/or the server system 106 over the network 110. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each of the server systems 104, 106 includes at least one server and at least one data store. In the example of FIG. 1, the server systems 104, 106 are intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a crowdfunding marketplace that enables multiple participants to securely and privately interact to push software development projects forward through to development. In some examples, and as described in further detail herein, the server system 104 and/or the server system 106 host and execute technical solutions that enable participants to securely and anonymously communicate through at least initial processes of a crowdfunding. For example, and as described in further detail herein, one or more pseudonymization services are provided that enable anonymous communication between parties through the crowdfunding marketplace. In this manner, implementations of the present disclosure provide a technical solution to address problems unique to Internet-based crowdfunding of software systems.

As described herein, implementations of the present disclosure provide a crowdfunding marketplace to support custom development of software systems. Implementations are described herein with reference to an external scenario and an internal scenario. In some examples, an external scenario includes a software vendor developing a software system for one or more customers (e.g., enterprises). In some examples, an internal scenario includes a development team that is internal to an enterprise, the development team developing a software system for internal use by the enterprise.

In accordance with implementations of the present disclosure, the crowdfunding marketplace enables stakeholders, also referred to herein as participants (e.g., software vendors, customers, inventors) to register for participation. For example, a participant can create an account with the crowdfunding marketplace and provide information to authenticate an identity of the participant (e.g., name, address, birthdate, license number, etc.). The crowdfunding marketplace securely stores the information (e.g., in a secure, encrypted database) to ensure the privacy of the participant, and, as described in further detail herein, provides one or more pseudonymization services are provided that enable direct, but anonymous communication between parties. In some examples, background checks can be done to ensure the integrity of the participants. For example, information provided by the participants can be checked against one or more databases to ensure that each participant is who they purport to be and are affiliated with an enterprise they purport to be affiliated with. This ensures a level of trust, because at least a portion of information shared in the crowdfunding marketplace can be confidential or otherwise sensitive information (e.g., intellectual property (IP)).

In some implementations, a solution owner (also referred to as an implementer) uses the crowdfunding marketplace to describe an idea for a project to be realized through a software system. The solution owner can publish, for example, the effort (e.g., external: money, market; internal: people, budget), the expected timeframe required to build the functionality, a recommended minimum investment share (e.g. at least one full-time employee (FTE), at least 10 k EUR cost). Potential interested parties (who are also registered with the crowdfunding marketplace) browse or are notified of proposals as they are published to the crowdfunding marketplace. In some examples, a number of presented projects can be limited in order to ensure that the interested parties can receive a newsletter (notification) about the proposed ideas, digest the proposals in a reasonable time and decide for investment (optimizations based on knowledge of who licensed which products may help to tailor the proposals to the most likely relevant ones).

In some implementations, potential investors, as participants, can indicate interest by registering to the promoted idea and issue an effort number (e.g., money, people) that they are willing to invest. Once the solution owner sees the project budgeted, the functionality is implemented by the solution owner and provided to the interested parties. Before the start of development, the crowdfunding marketplace enables a negotiation phase to balance the effort between the participants and adjust the scope of the project in order accommodate special needs of the participants.

In accordance with implementations of the present disclosure, the crowdfunding marketplace provides one or more pseudonymization services are provided that enable direct, anonymous communication between parties. As used herein, pseudonymization refers to a process of obfuscating actual information of replacing actual information (e.g., the actual information identifying or having potential to identify an entity, such as a user, an enterprise)) with pseudo-information (e.g., the pseud-information not identifying or reducing potential to identify the entity). In some examples, the pseudonymization services correspond to respective communications channels (e.g., email, instant messaging, video-conferencing, VOIP telephony). In some examples, each pseudonymization service obfuscates participant identities to enable participants to securely and anonymously interact through at least a portion of the processes described herein, which are executed to bring a software system to development. For example, communications between participants are intercepted and one or more pseudonymization techniques are applied to the communication to obfuscate an identity of the participant and/or an enterprise that the participant represents. Example pseudonymization techniques can include, without limitation, changing or obfuscating email addresses and/or signature blocks in emails, and obfuscating a telephone number in telephonic communications (e.g., VOIP). In some examples, pseudonymization techniques are applied until a defined point during the processes (e.g., all participants have signed a contract to begin development of the software system). In some examples, pseudonymization techniques are applied for a participant until the participant provides an indication that obfuscation is no longer required for the participant for the particular project.

Contracts are also facilitated through the crowdfunding marketplace to consider terms (e.g., the ownership and maintenance of the resulting code). In some examples, contract templates implementing fair best practices can be provided by the crowdfunding marketplace. In some examples, if an idea is agreed and development of the software system is to commence, the idea can be removed from the marketplace. This can be the case, when the contracts between requesters and/or investors and the implementer is signed.

With particular reference to the external scenario, it is important to protect both parties: implementers from IP theft, requesters from revealing their internal situation and needs. With regard to implementer protection, in order to prevent IP theft and/or any other legal obligations that may be respected, signed non-disclosure agreements (NDAs) as well as signed contracts for the development are exchanged through the crowdfunding marketplace. With regard to investor protection, the crowdfunding marketplace can implement a level of privacy. For example, in the case of multiple investors, the investors are unable to discern each other, all negotiations—contractual and scope are only visible to the implementer and a single investor. To achieve this, the crowdfunding marketplace of the present disclosure provides a virtual collaboration room that enables the implementer to distribute the same information to all requesters and/or investors, interact with each in privacy, and consolidate the private discussion into updated information to be distributed again to others. This means that only the implementer has the full picture. Requesters/investors only see their own interactions with the implementer and the information that the implementer chooses to distribute to all. In some cases, a requester/investor can even choose to negotiate.

In the external scenario, a software vendor can provide the crowdfunding marketplace of the present disclosure. For example, the software vendor can offer access to the crowdfunding marketplace as an extension to current custom development activities (e.g., another channel to satisfy customer needs). Normally, custom development of a software system is a one-on-one relationship between the software vendor and a customer. The crowdfunding marketplace of the present disclosure enables a one-to-many relationship in custom development. In this manner, the software vendor is able to strengthen the value of software solutions for the customer (requester), and gains a competitive advantage to competitors in regard to the so-called “customer for life” paradigm, as well as over consulting companies in regard to tapping otherwise non-addressable market share of custom development.

With particular reference to the internal scenario, the crowdfunding marketplace can be combined with an inner source approach. In contrast to the external scenario, legal protection (e.g., protecting IP) plays less of a role. However, one consideration in the internal scenario is support of a jointly developed component. Like with open source components, the first level of support is certainly with the consumer of the component. Effectively, this can mean that patches must be provided by forking the component before the patch is included through the component community. Certainly, in the internal scenario, the community is smaller than in the case of open source.

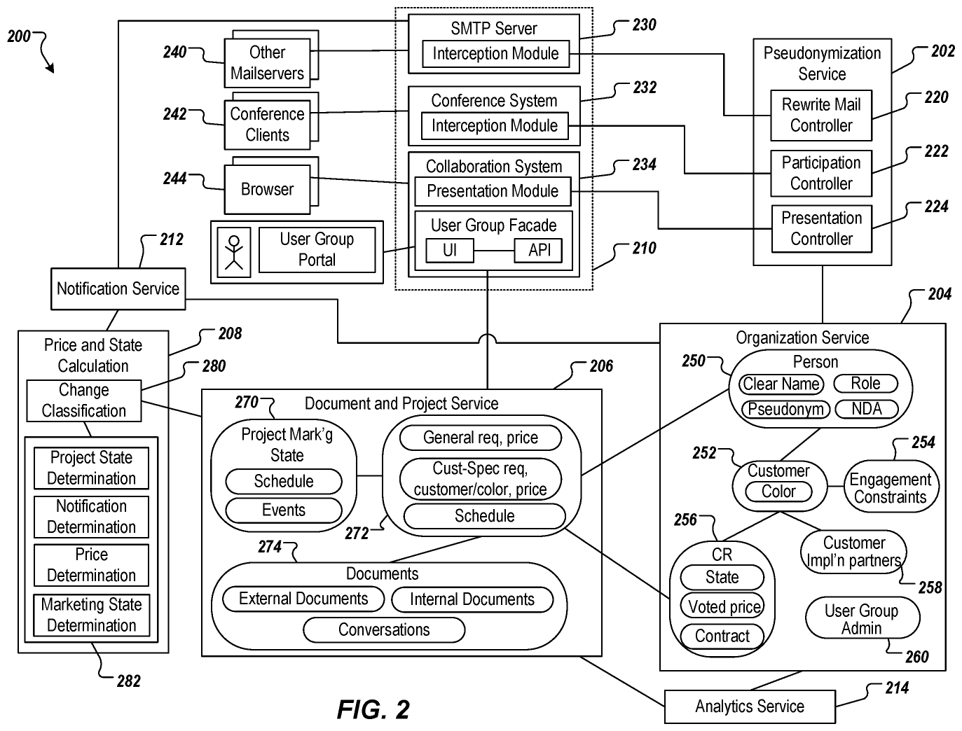

FIG. 2 depicts an example conceptual architecture 200 for a crowdfunding marketplace in accordance with implementations of the present disclosure. The example conceptual architecture 200 includes a pseudonymization service 202, an organization service 204, a document and project service 206, and a price and state calculation service 208, and communication systems 210. The example conceptual architecture 200 also includes a notification service 212 and an analytics service 214.

In accordance with implementations of the present disclosure, the pseudonymization service 202 enables participants in the crowdfunding marketplace to remain private, while enabling communication therebetween. In further detail, the pseudonymization service 202 includes a rewrite mail controller 220, a participation controller 222, and a presentation controller 224. In some examples, the communication systems 210 include an email server 230, a conference system 232, and a collaboration system 234. The email server 230 communicates with one or more external mail servers 240 (i.e., external to the crowdfunding marketplace), the conference system 232 communicates with one or more conference clients 242 (i.e., external to the crowdfunding marketplace), and the collaboration system 234 communicates with one or more browsers 244 (e.g., executed on a client device external to the crowdfunding marketplace).

In some implementations, the pseudonymization service 202 executes functionality described herein through coordination with the organization service 204. In the example of FIG. 2, the organization service 204 includes participant data 250 (e.g., name, role, pseudo-name assigned, NDA status (whether signed to an NDA)), customer data 252 (e.g., a color used to represent the customer within the crowdfunding marketplace), engagement constraint data 254 (e.g., constraints a customer may have in committing to work), customer relationship (CR) data 256 (e.g., a state, voted prices on projects, contract data), customer implementation partner data 258, and user group administration data 260.

In the example of FIG. 2, the document and project service 206 includes project marketing state data 270, project data 272, and a document store 274.

In the example of FIG. 2, the price and state calculation service 208 includes a change classification module 280 and a set of determination modules 282. In some examples, the change classification module 280 receives data from the document and project service 206, and processes the data to identify occurrences of a change (e.g., in state of a customer, project, etc.) and routes the data to an appropriate determination module in the set of determination modules 282. The selected determination module can process the data to update based on the change (e.g., update a state based on a change), which information can be updated within the crowdfunding marketplace (e.g., within the document and project service 206). In some examples, the price and state calculation service 208 can be used to enable customers to define their price proposal per requirement and have a private calculation of their cost and ROI. This can imply a private, encrypted persistency (key store/generation infrastructure) for storing customer comments. Indications can also be provided as to whether, for example, requirements have changed and/or comments are outdated.

In some implementations, the notification service 212 is prompted by changes in the crowdfunding marketplace (e.g., changes are pushed to the notification service 212 by the organization service 204 and/or the price and state calculation service 208), and, in response, transmits notifications to one or more participants through one or more channels (e.g., email). Accordingly, the notification service 212 keeps customers updated about changes occurring in the crowdfunding marketplace, which are relevant to a project that the customer is a participant in. Example notifications can include notifications related to marketing of a project to other participants (e.g., update on event, once a day or critical mass if new interested parties join) and notifications related to an on-going project (e.g., update on changes of the requirements documents, requesting approval/vote of change and/or cost).

In accordance with implementations of the present disclosure, participants communicate with the crowdfunding marketplace through one or more of the external mail servers 240, the conference clients 242, and/or the browsers 244, which traffic is routed to the pseudonymization service 202 through the respective components of the communication systems 210. For example, users of the crowdfunding marketplace (e.g., individuals, enterprise) can register an account with the crowdfunding marketplace. In some examples, each account includes information that could be used to identify the respective user (e.g., name, company name, telephone number, email address). In some examples, each account is associated with an email address that is of a domain of the crowdfunding marketplace (e.g., @crdfndg.com) and participants use the email address to communicate with other participants through the crowdfunding marketplace. That is, because the email address is of the domain of the crowdfunding marketplace, email messages are transmitted to/from the email server 230 for interception and pseudonymization.

In some examples, for each account, the pseudonymization service 202 generates pseudo-information (obfuscation) for the account information and maps each account to such. For example, an actual name can be mapped to a pseudo-name. As another example, an actual email address in account information can be mapped to a pseudo-email address. By way of non-limiting example, a user, Sheryl, can be assigned the email address sheryl@crdfndg.com for communication with the crowdfunding marketplace through the email server 230. In some examples, the user's actual email address (e.g., stored as account information) is mapped to the email address assigned for the crowdfunding marketplace. In some examples, the pseudo-address 16834@crdfndg.com can be generated and mapped to the email address sheryl@crdfndg.com. Accordingly, other participants can email Sheryl through the crowdfunding marketplace using 16834@crdfndg.com, such that email messages can be addressed to and received by Sheryl without the senders becoming aware of the actual name, Sheryl.

In some examples, the pseudo-information and/or obfuscation are randomly generated using a randomizer (e.g., a computer-executable program that generates random characters and/or character strings). In some examples, the pseudo-information and/or obfuscation are provided as hash values that are generated by inputting account information into a hash function (e.g., SHA-256).

In some implementations, pseudo-information is generated for each participant on a project-by-project basis. For example, multiple sets of pseudo-information can be provided for a user, each set of pseudo-information corresponding to a project that the user is participating in through the crowdfunding marketplace. In this manner, the same pseudo-information is not used for multiple projects to avoid information leakage (e.g., the same pseudo-information is used for projects related to cybersecurity, and as such, other participants could deduce that the user underlying the pseudo-information is involved in cybersecurity).

In some examples, the pseudonymization service 202 intercepts communications (e.g., email traffic using an interception module of the email server 230), uses pseudo-addresses for participants (e.g., pseudo-addresses) to distribute emails through the email server 230. Continuing with the example above, an email can be addressed to 16834@crdfndg.com, which the pseudonymization service 202 maps to the user Sheryl and can forward the email to Sheryl (e.g., at Sheryl's actual email address).

In some examples, the pseudonymization service 202 processes messages to identify information that reveals actual information about participants and replaces and/or obfuscates the actual information. In some examples, actual information can be identified by passing the message through one or more filters and/or applying one or more rules.

An example filter can include a name filter to identify occurrences of names. For example, character strings of a message can be compared to names provided in a name filter and, if a character string matches a name of the name filter, the character string can be replaced or obfuscated within the message before the pseudonymization service 202 forwards the message to recipients. Another example filter can include a pattern filter that can be used to identify patterns that can indicate potential inclusion of actual information. Example patterns can include, without limitation, a heading pattern, a greeting pattern, a signature line pattern, and a signature block pattern. In some examples, each pattern can be defined as a regular expression where, if a string of characters of a message matches the regular expression, the pattern is identified as being included in the message.

In some examples, the one or more rules can define how actual information is to be pseudonymized. For example, and without limitation, it can be determined that a character string is potentially provided as actual information within a message and can be included in a portion of the message that matches a pattern. In this case, a rule can be provided that includes: if actual information is included in pattern of type, replace the actual information with specified pseudo-information. By way of non-limiting example, the user, Sheryl, can send an email that includes the signature line “Sincerely, Sheryl.” The one or more filters can recognize the signature line as such using a signature line pattern (e.g., the pattern is of type signature block) and can identify Sheryl as a name using a name filter. In response, the pseudonymization service 202 can change the signature line to “Sincerely, 16834@crdfndg.com.” For example, a rule can be provided that includes: if actual information is included in pattern of type signature block, replace the actual information with pseudo-address of sender.

In some examples, the pseudonymization service 202 enables telephone conferences through the conference system 232 by, for example, routing telephone calls to obfuscate telephone numbers from participants. In some examples, the pseudonymization service 202 enables video-conferences through the collaboration system 234 by, for example, routing video feeds to obfuscate information (e.g., names, IP address) from participants. The pseudonymization service 202 carries out the recognition and replacement of clear user data (names, phone numbers) with pseudonymized user data (most prominently pseudonyms, but also organizations) and vice-versa for the different communication channels. For this purpose, the pseudonymization service 202 uses the organization services 204 in order to retrieve the mapping between clear and pseudonymized user data.

In some implementations, the pseudonymization service 202 pseudonymizes communications until occurrence of one or more events. In some examples, pseudonymization is provided as a default until an event occurs. An example event can include a participant indicating that they do not require pseudonymization. For example, a participant can decide that they do not require pseudonymization and can provide input to the crowdfunding platform indicating such. For example, a user can log into their account with the crowdfunding marketplace and adjust a privacy setting to indicate that pseudonymization is not required. In some examples, the user can define the privacy settings on a project level (e.g., indicate that pseudonymization is not required for a particular project, but maintain pseudonymization for other projects).

Another example event can include a project achieving a defined milestone. An example milestone can include one or more contracts (e.g., NDA) being established between the participants in the project. For example, and without limitation, the crowdfunding marketplace can determined that each participant in a project have signed a NDA (e.g., the participants have individually signed and/or the enterprises the participants respectively represent have signed). In response to occurrence of the event, pseudonymization is not performed for communications between participants of the project afterward. In some examples, milestones are project-specific, such that achieving a milestone results in discontinuance of pseudonymization only for the project that the milestone is specific to. For example, a participant can participate in a first project and a second project within the crowdfunding marketplace. In response to a milestone being achieved within the first project, pseudonymization is discontinued in communications associated with the first project. However, pseudonymization continues in the second project.

In some implementations, the analytics service 214 enables analytics to be performed across one or more projects developed through the crowdfunding marketplace. In some examples, analytics can include project prediction. For example, an overall cost and eventual margin depend on timely negotiation of a project. This has to be streamlined to cut cost without revenue. From the onset, a project can be measured based on a distribution of participants (e.g., associated with explicit marketing campaigns), and success of campaigns. In some examples, analytics can be performed on a project to determine a likelihood that there will be sufficient commitment to the project by analyzing the comment behavior of individual contributors,

Example metrics that can be considered in analytics can include, without limitation, participant behavior (e.g., based on comment frequency, difference of pricing vote, frequency of use of the crowdfunding marketplace), correlate between participant behavior and success in the past, duration of negotiations, responsiveness of participants (e.g., how quickly are votes cast and reacted to any offline request or notification), frequency of comments and interactions, and correlation with success of software systems that had previously resulted from the crowdfunding marketplace. In some examples a participant engagement index can be calculated, which represents engagement frequency and timeliness. In some examples, analytics can be provided based on comparing the participant engagement index to project mean, difference to past, difference to projects past, for example.

In general, participants in the crowdfunding marketplace can be characterized in a set of personas. Personas can include, but are not limited to, the example personas summarized in Table 1, as follows:

TABLE 1
Example Personas

| Persona | Title | Description |
|---|---|---|
| Pe1 | Crowdfunding Marketplace | Gatekeeper for project |
| | Operator (CMO) | proposals and development. |
| Pe2 | Solution Owner | Person responsible for |
| | | development of particular |
| | | software system and project |
| | | scope. |
| Pe3 | Crowdfunded | Organizes the entire project |
| | Project Lead | together with Solution Owner, |
| | | coordinates local engagement |
| | | managers, and responsible for |
| | | all deadlines. |
| Pe4 | Development Lead | Responsible for and |
| | | knowledgeable about |
| | | implementing project scope. |
| | | Carries out effort |
| | | estimation/cost, development |
| | | and delivery of the software |
| | | system. |
| Pe5 | Customer Commitment | Authorized to commit to project |
| | Lead (CCL) | on behalf of a customer. |
| Pe6 | Customer LOB | Represents customer interests in |
| | Representative | project for particular line-of- |
| | | business (LOB). |
| Pe7 | Customer Development | Responsible for implementing |
| | Representative (CDR) | and maintaining software |
| | | system at the customer resulting |
| | | from project. |
| Pe8 | Customer Account | Person at software vendor |
| | Executive (CAE) | responsible for particular |
| | | customer. |
| Pe9 | Local Engagement | Regional standards (e.g., IBSO) |
| | Manager | representative for customer |
| | | engagements, interacting with |
| | | customers to prepare contracts |
| | | for the crowd-founded solution |

The crowdfunding marketplace of the present disclosure facilitates execution of multiple processes, as described in further detail herein.

In some examples, a first process (P1) includes publishing of project proposals to the crowdfunding marketplace and selecting project candidates for development. For example, a solution owner can seek approval of a project proposal (e.g., promote project state to candidate state) and receive a budget and sponsor for the project preparation. In some examples, a second process (P2) includes authoring of a project. For example, the solution owner and the development lead can provide all required documents to market the project and give reasonable detail to interested customers (participants). In some examples, a third process (P3) includes publishing of the project to the crowdfunding marketplace. For example, a high-level vision and scope document is published to the crowdfunding marketplace and customer prospects are identified. In some examples, a fourth process (P4) includes marketing of the project. For example, customer prospects can be contacted in order to get a list of customers that may have interest in the project.

In some examples, a fifth process (P5) includes negotiating project scope details. For example, the solution owner and development lead discuss and agree to the scope with the customer contacts. In some examples, a sixth process (P6) includes negotiating commercial details without a final price. For example, commercial details are communicated to customers to understand the contract template and commercial model, agree to it with the result of a contract draft. In some examples, a seventh process (P7) includes a “go” or “no-go” decision to start development. For example, scope and contract draft are agreed to, and a final price is set. In some examples, P5 and P6 are performed in parallel, and P7 is only executed after the outputs of both P5 and P6 are available.

In some examples, an eighth process (P8) includes finalizing contracts. For example, contracts with final prices are signed by customers and the software vendor. In some examples, a ninth process includes starting the project (i.e., starting development of the software system), a tenth process (P10) includes conducting customer payments (e.g., per a contractually-defined payment schedule), an eleventh process (P11) includes reporting project progress to customers, and a twelfth process (P12) includes delivery and testing project iteration.

In some examples, a thirteenth process (P13) can include changing project scope, if needed. In some examples, a fourteenth process (P14) includes accepting the software system as developed per the project, a fifteenth process (P15) includes deploying the software system for production use, a sixteenth project (P16) includes closing the project within the crowdfunding marketplace, and a seventeenth process (P17) includes providing customer support (e.g., responding to incident tickets).

One or more other processes may come into play and be executed using the crowdfunding marketplace. For example, an eighteenth process (P18) can include aborting a project, a nineteenth process (P19) can include cross-selling the project and/or resulting software system to other customers, a twentieth process (P20) can include ensuring continuous success, and a twenty-first process (P21) can include reopening a project for enhancements.

Management of the crowdfunding marketplace itself implies additional processes (e.g., executed by the CMO (Pe1)). For example, a twenty-second process (P22) can include organizing and governing all projects within the crowdfunding marketplace, and a twenty-third process (P23) can include collecting analytical data for future process optimizations.

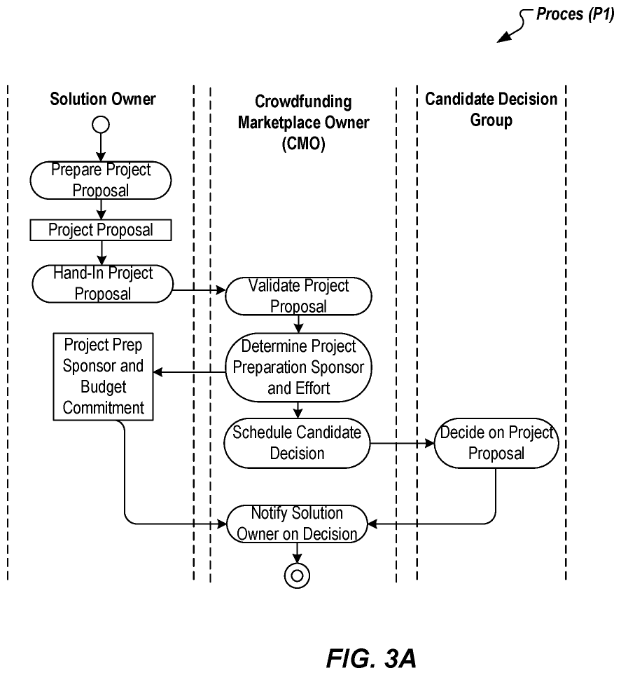

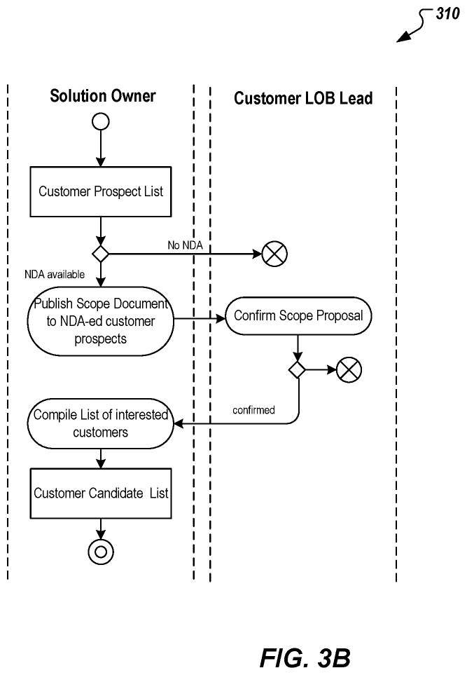

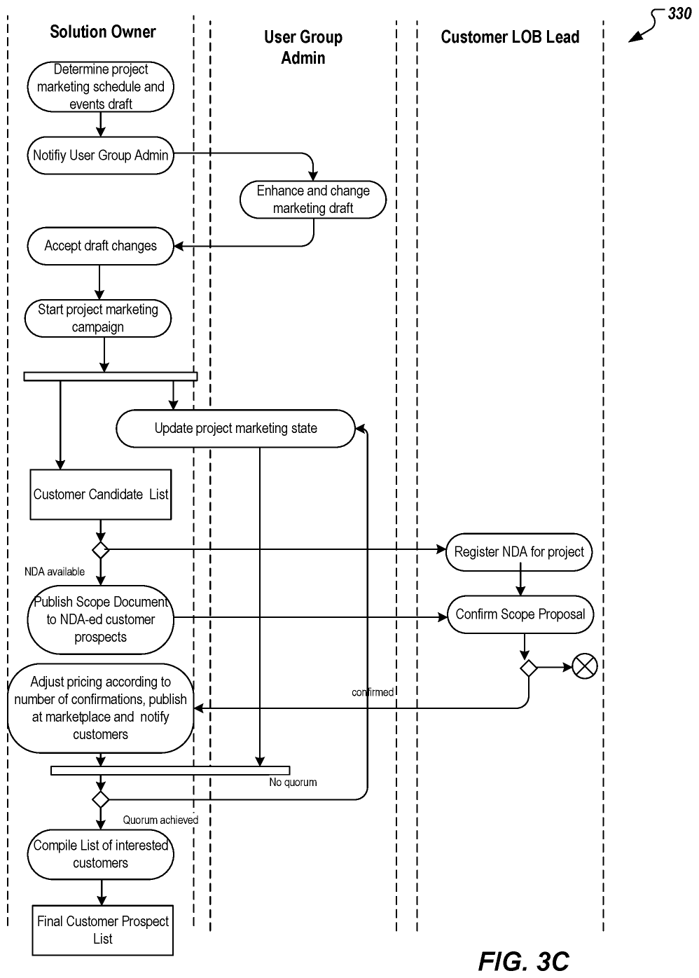

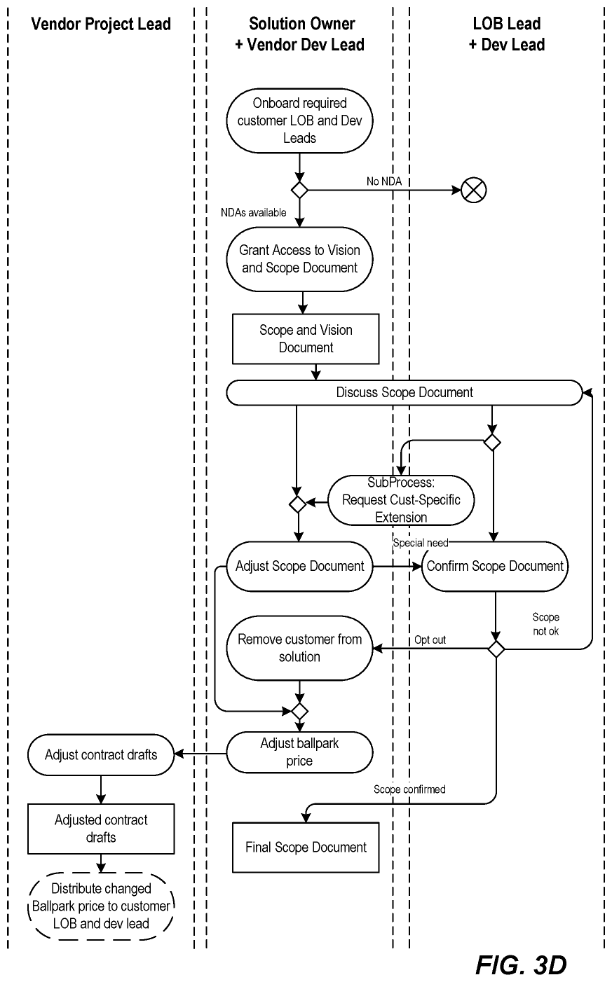

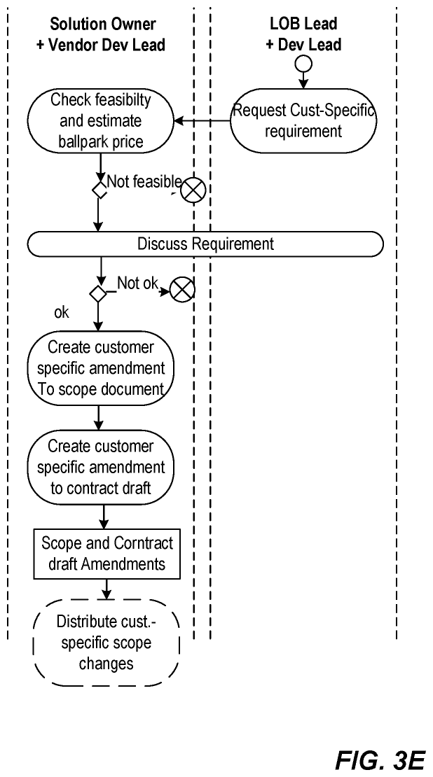

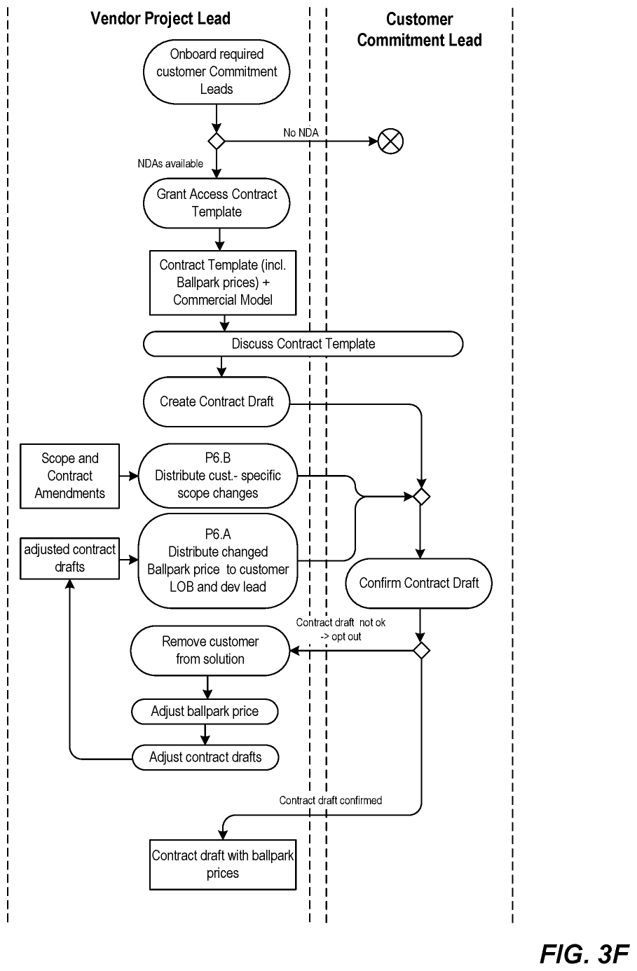

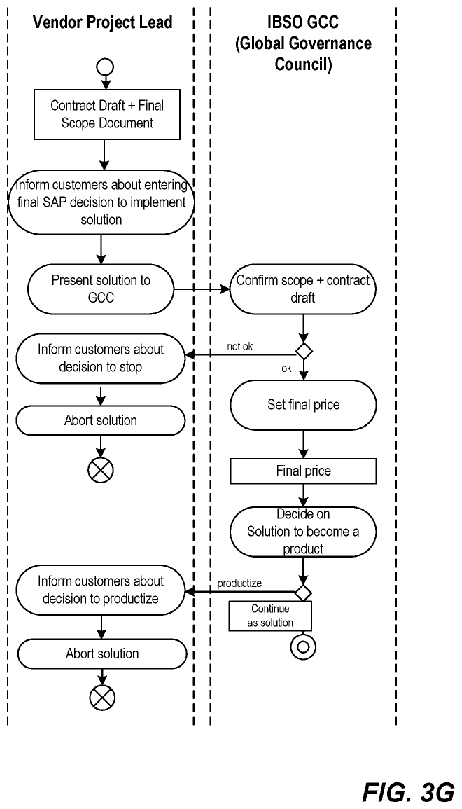

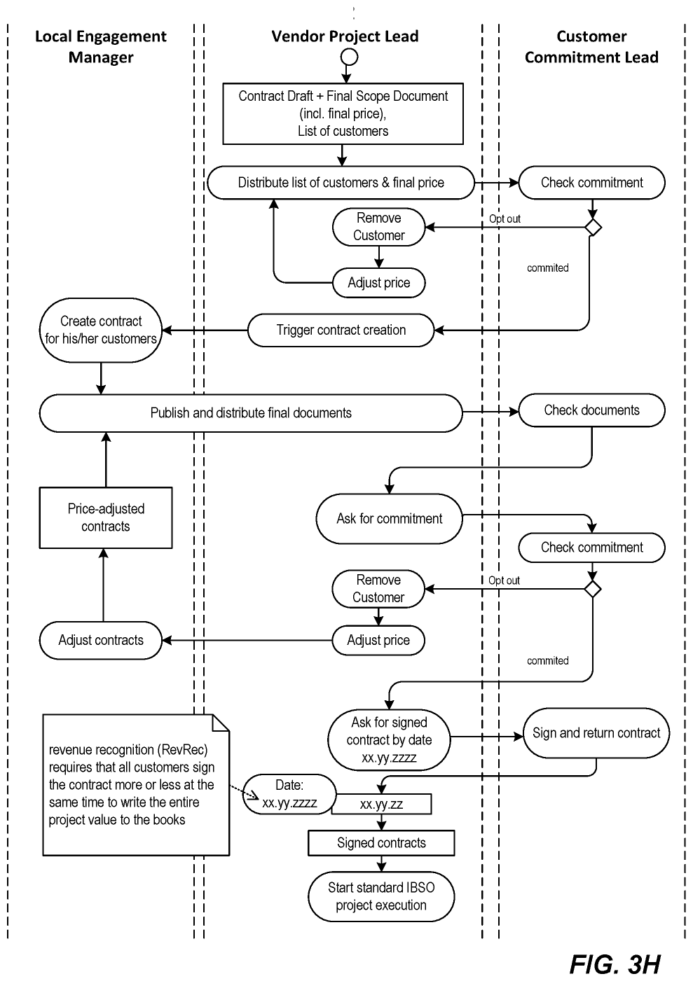

The above-identified processes are generally provided in the order of a crowdfunding project lifecycle through the crowdfunding marketplace of the present disclosure. FIGS. 3A-3H depict example processes in further detail.

FIG. 3A depicts an example of the first process (P1). In P1, a goal can be defined as a solution owner seeking a decision board (e.g., one or more stakeholders including, for example, the CMO) to approve a project proposal and receive a budget and sponsor for preparation of the project. Example personas that participate in P1 include, but are not limited to, the solution owner, the CMO, and a decision board (e.g., one or more personas, such as the CMO). An input to P1 can be provided by the solution owner and includes a description of a project proposal as a computer-readable file. In some examples, the description includes a one-page business case, first cost estimation, value proposition, and a price per customer, commitment of the management of the solution owner to go the next steps. An output of P1 can include a state of the project proposal being promoted to candidate, of the proposal is refused or deferred. In some examples, if the state of the project proposal is promoted to candidate, a sponsor for subsequent project authoring (=project preparation), and approved budget for project preparation are provided.

As depicted in FIG. 3A, the solution owner addresses the CMO with a request to assess the project proposal. The CMO runs a quality gate with a decision group to determine whether the project proposal becomes a candidate, and, if so, determines a sponsor for project preparation (authoring, marketing, . . . ). Further, the effort/budget for next steps (next steps=all processes until P8 (finalize contracts)) are defined and approved, and confirmation of a non-binding pricing forecast (i.e. project cost per customer) is provided (e.g., ballpark approval).

In the second process (P2), a goal is that the solution owner and the development lead provide all required documents to market the project and give reasonable detail to interested customers. In some examples, input to P2 includes a project proposal, and output of P2 includes a high-level vision and scope document (not all details yet available). Personas that perform P2 can include the solution owner and the development lead.

In the third process (P3), a goal is that the high-level vision and scope document of P2 is published to the crowdfunding marketplace and customer prospects are identified. In some examples, input to P3 includes the high-level vision and scope document, and output includes a list of customer contacts (customer prospect list). Personas that participate in P3 can include the CMO, the solution owner, and CAEs. In general, the flow of P3 can include the CMO publishing the high-level scope document to the crowdfunding marketplace, the solution owner creating a preliminary list of customers (customer prospect list), and the solution owner contacting CAEs of the already known customer prospects and providing the published scope document.

FIG. 3B depicts an example of the fourth process (P4). In executing P4, a goal is to contact customer prospects in order to get a list of customers with interest in the project. In some examples, an input to P4 is a list of customer prospect contacts (customer prospect list), and an output of P4 is a list of customers with interest in the project (customer candidate list). Personas participating in P4 can include the solution owner, and customer LOB leads for respective customers. In some examples, a constraint to P4 being performed is whether NDAs from customers are available. In some examples, access to the project scope document within the crowdfunding marketplace is only available to a customer, if a NDA is present.

FIGS. 3C and 3D depict respective examples of the fifth process (P5). FIG. 3D depicts a more detailed version of P5 than FIG. 3C. In executing P5, a goal includes the solution owner and the development lead discussing and agreeing to the scope with customer contacts. In some examples, input to P5 is the high-level vision and scope document, and output includes an agreed final scope by customers provided in an updated scope document. Example personas participating in P5 include the solution owner, the development lead, the customer LOB lead(s), and the customer development lead(s). FIG. 3E depicts an example extension of P5 to account for customer-specific amendments.

FIG. 3F depicts an example of the sixth process (P6). In P6, a goal includes customers understanding the contract template and commercial model and agreeing to both. In some examples, input to P6 includes a contract template and output includes an agreed contract draft. Personas that participate in P6 can include a customer commitment lead, and the project lead of the software vendor. In general, the flow of P6 includes the project lead initiating discussions with customers (commitment lead) and internal groups. At this point still only ballpark prices are known and communicated, final prices are to be determined later in P7. In P6, the customers are led through the commercial model and the contract template.

FIG. 3G depicts an example of the seventh process (P7). In P7, a goal can include agreement of a governance council to scope and contract draft and setting of the final price. In some examples, input to P7 includes a final scope document and contract draft, and output of P7 includes a go-decision and final price, or no-go decision (abort). Personas that can participate in P7 include the project lead of the software vendor and the governance council.

FIG. 3H depicts an example of the eighth process (P8). In P8, a goal includes getting contracts with final prices signed by customers. In some examples, input to P8 includes a final scope document, a contract draft with final prices, and a list of customers, and output includes signed customer contracts. Personas participating in P8 can include the project lead of the software vendor, customer commitment lead(s), and local engagement managers. Ideally, the number of signed contracts is equal to the number of customers present in the input list of customers. Nevertheless, P8 accommodates that customers might opt-out once the final price is communicated at the beginning of the process. Therefore, the adjustment of the price per customer is addressed in P8 in order to make sure that the cost (e.g., development, margin) to the software vendor, which are independent from the number of customers, are covered at any point in time.

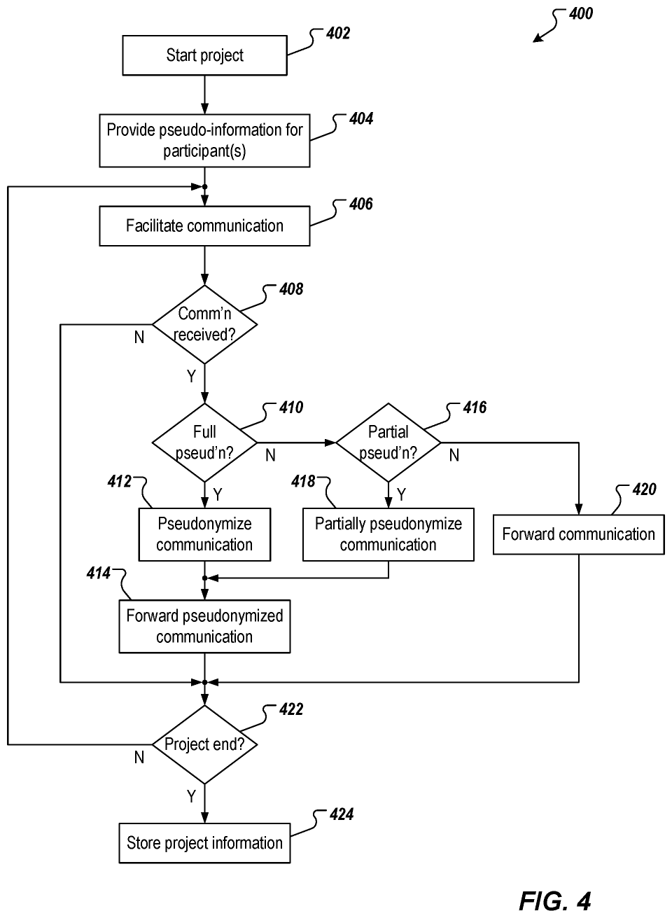

FIG. 4 depicts an example process 400 that can be executed in accordance with implementations of the present disclosure. In some examples, the example process 400 is provided using one or more computer-executable programs executed by one or more computing devices. The example process 400 can be executed for anomaly detection in accordance with implementations of the present disclosure.

A project is started (402). For example, and as described herein, an implementer or a requester can publish an idea for a software system to the crowdfunding marketplace of the present disclosure, and a set of participants can express interest in engaging on potential development of the software system. In response, a project for facilitating one or more processes described herein (e.g., processes of FIGS. 3A-3H) can be started, the set of participants participating in the project. Pseudo-information is provided for participants (404).

Communication is facilitated (406). For example, and as described herein with reference to FIG. 2, the pseudonymization service 202 and the communication systems 210 enable participants to communicate with one another and/or with the crowdfunding marketplace through one or more channels (e.g., email, instant messaging, video-conferencing).

It is determined whether a communication is received (408). For example, and as described herein, an interceptor can intercept a communication between participants through a channel (e.g., email) and, in response, determine that a communication has been received. If a communication is not received, it is determined whether the project is ended (422). Here, project can refer to activities to either come to agreement on development of the software system, or abandoning the effort to agree on development of the software system. For example, it can be determined whether the project has reached a particular milestone (e.g., contracts in place and development of software system is to begin; no agreement achieved and participants abandoning effort) and, if the milestone has been reached, it is determined that the project has ended. If the project is not ended, the example process 400 loops back. If the project is ended, project information is stored (424).

If a communication is received, it is determined whether full pseudonymization is to be performed (410). For example, it is determined whether pseudonymization is to be performed for all participants involved in the communication (e.g., sender(s), recipient(s)). In some examples, and as described herein, a participant may elect not to have pseudonymization performed. In such an example, full pseudonymization is to be performed assuming at least one other participant is still to have pseudonymization. As another example, and as described herein, if the project achieves a particular milestone (e.g., contracts signed), it can be determined that full pseudonymization is no longer to be performed.

If full pseudonymization is to be performed, the communication is pseudonymized (412) and the pseudonymized communication is forwarded (416). For example, and as described herein, a pseudonymized communication can be provided by replacing actual information within the communication with pseudo-information and/or obfuscating actual information.

If full pseudonymization is not to be performed, it is determined whether partial pseudonymization is to be performed (416). For example, it is determined whether pseudonymization is to be performed for at least one participant involved in the communication (e.g., sender(s), recipient(s)). In some examples, and as described herein, a participant may elect not to have pseudonymization performed. In such an example, full pseudonymization is to be performed assuming at least one other participant is still to have pseudonymization. As another example, and as described herein, if the project achieves a particular milestone (e.g., contracts signed), it can be determined that partial pseudonymization is no longer to be performed. If partial pseudonymization is to be performed, the communication is partially pseudonymized (418) and the pseudonymized communication is forwarded (416). For example, and as described herein, a pseudonymized communication can be provided by replacing actual information within the communication with pseudo-information and/or obfuscating actual information.

If partial pseudonymization is not to be performed, the communication is forwarded (420) and the example process 400 continues as described herein.

Implementations of the present disclosure achieve one or more technical advantages. For example, and as described herein, pseudonymization is provided to facilitate communication between participants with anonymity. A technical problem that is unique to communicating through computer-implemented, network-based is that data representative of entities (e.g., users and/or enterprises using the communication channels) is required to enable communication. However, such data, if not revealing the actual identity of the entities, can leak information that can be used to determine the identity of the entities. The pseudonymization of the present disclosure enables a crowdfunding marketplace that provides anonymous communication between parties and minimizes data leakage. Further, implementations of the present disclosure provide digressive pseudonymization, which includes, for example, relatively robust pseudonymization at the outset of a project that digresses to little or no pseudonymization as the project progresses to an end point (e.g., participants agreeing to start development of the software system, participants abandoning development of the software system). In this manner, technical resources (e.g., processors, memory) expended to pseudonymize communications are reduced as the project progresses (e.g., achieves milestones, in response to which pseudonymization is reduced or ended). Implementations of the present disclosure also enable participants to opt-out of pseudonymization providing a further means to at least incrementally reduce pseudonymization, and the resulting burden on technical resources, as the project progresses. Further, implementations of the present disclosure enable granular, project-level pseudonymization to also reduce the burden on technical resources, as not all projects, many of which can be concurrent, require the same level of pseudonymization.

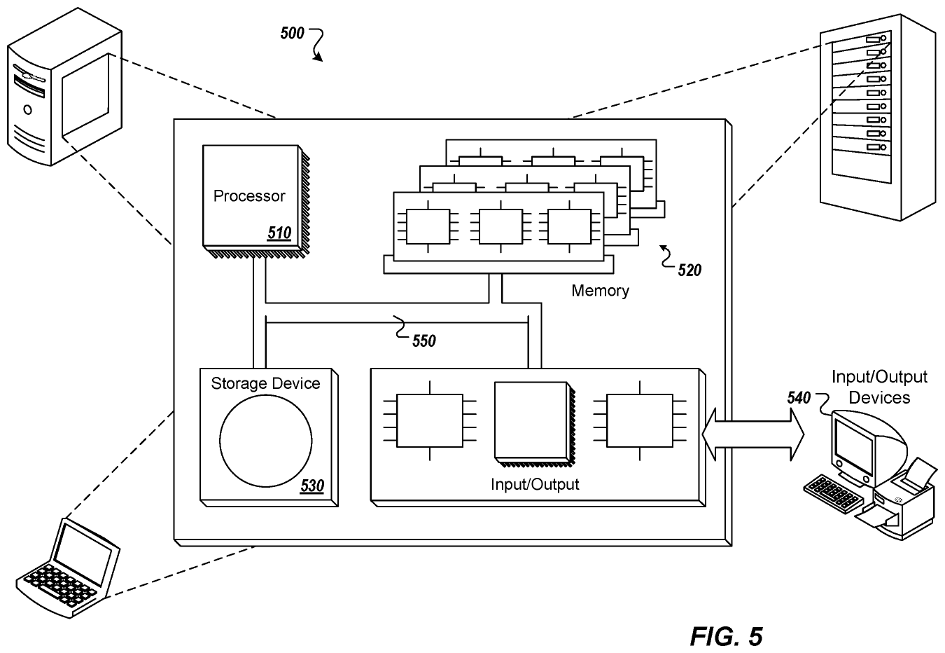

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550.

The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for a crowdfunding marketplace for custom development of software systems, the method being executed by one or more processors and comprising:
initiating a project within a crowdfunding marketplace, the project comprising a set of participants to communicate with one another through the crowdfunding marketplace;
receiving a communication from a first sub-set of participants to a second sub-set of participants, the first sub-set of participants comprising at least one participant, and the second sub-set of participants comprising at least one participant, the communication comprising a network-based communication;
pseudonymizing, by a pseudonymization service, at least a portion of the communication to provide a pseudonymized communication;
sending the pseudonymized communication to the second sub-set of participants; and
decreasing pseudonymization of communications during progression of the project to reduce burden on technical resources expended for pseudonymization.

2. The method of claim 1, wherein pseudonymization is decreased from a first level to a second level during progression of the project.

3. The method of claim 2, wherein the second level comprises no pseudonymization.

4. The method of claim 1, wherein the second level is implemented in response to an event associated with the project.

5. The method of claim 1, wherein the communication comprises one of an email message, an instant message, video communication, and a voice-over-internet-protocol (VOIP) message.

6. The method of claim 1, wherein pseudonymizing at least a portion of the communication comprises replacing the at least a portion of the communication with pseudo-information associated with at least one participant, the at least a portion of the communication comprising actual information representative of the at least one participant.

7. The method of claim 1, wherein pseudonymizing at least a portion of the communication comprises obfuscating the at least a portion of the communication, the at least a portion of the communication comprising actual information representative of the at least one participant.

8. A non-transitory computer-readable storage medium coupled to one or more processors and having instructions stored thereon which, when executed by the one or more processors, cause the one or more processors to perform operations for a crowdfunding marketplace for custom development of software systems, the operations comprising:
initiating a project within a crowdfunding marketplace, the project comprising a set of participants to communicate with one another through the crowdfunding marketplace;
receiving a communication from a first sub-set of participants to a second sub-set of participants, the first sub-set of participants comprising at least one participant, and the second sub-set of participants comprising at least one participant, the communication comprising a network-based communication;
pseudonymizing, by a pseudonymization service, at least a portion of the communication to provide a pseudonymized communication;
sending the pseudonymized communication to the second sub-set of participants; and
decreasing pseudonymization of communications during progression of the project to reduce burden on technical resources expended for pseudonymization.

9. The computer-readable storage medium of claim 8, wherein pseudonymization is decreased from a first level to a second level during progression of the project.

10. The computer-readable storage medium of claim 9, wherein the second level comprises no pseudonymization.

11. The computer-readable storage medium of claim 8, wherein the second level is implemented in response to an event associated with the project.

12. The computer-readable storage medium of claim 8, wherein the communication comprises one of an email message, an instant message, video communication, and a voice-over-internet-protocol (VOIP) message.

13. The computer-readable storage medium of claim 8, wherein pseudonymizing at least a portion of the communication comprises replacing the at least a portion of the communication with pseudo-information associated with at least one participant, the at least a portion of the communication comprising actual information representative of the at least one participant.

14. The computer-readable storage medium of claim 8, wherein pseudonymizing at least a portion of the communication comprises obfuscating the at least a portion of the communication, the at least a portion of the communication comprising actual information representative of the at least one participant.

15. A system, comprising:
a computing device; and
a computer-readable storage device coupled to the computing device and having instructions stored thereon which, when executed by the computing device, cause the computing device to perform operations for a crowdfunding marketplace for custom development of software systems, the operations comprising:
initiating a project within a crowdfunding marketplace, the project comprising a set of participants to communicate with one another through the crowdfunding marketplace;
receiving a communication from a first sub-set of participants to a second sub-set of participants, the first sub-set of participants comprising at least one participant, and the second sub-set of participants comprising at least one participant, the communication comprising a network-based communication;
pseudonymizing, by a pseudonymization service, at least a portion of the communication to provide a pseudonymized communication;
sending the pseudonymized communication to the second sub-set of participants; and
decreasing pseudonymization of communications during progression of the project to reduce burden on technical resources expended for pseudonymization.

16. The system of claim 15, wherein pseudonymization is decreased from a first level to a second level during progression of the project.

17. The system of claim 16, wherein the second level comprises no pseudonymization.

18. The system of claim 15, wherein the second level is implemented in response to an event associated with the project.

19. The system of claim 15, wherein the communication comprises one of an email message, an instant message, video communication, and a voice-over-internet-protocol (VOIP) message.

20. The system of claim 15, wherein pseudonymizing at least a portion of the communication comprises replacing the at least a portion of the communication with pseudo-information associated with at least one participant, the at least a portion of the communication comprising actual information representative of the at least one participant.
